(19) United States
(12) Patent Application Publication
(10) Pub. No.: US 2026/0042250 A1
(43) Pub. Date: Feb. 12, 2026

(54) ADVANCED VISCO-SEALS FOR SINGLE SCREW EXTRUDERS

(71) Applicant: Dow Global Technologies LLC, Midland, MI (US)

(72) Inventors: Mark A. Spalding, Midland, MI (US); Xiaofei Sun, Lake Jackson, TX (US)

(73) Assignee: Dow Global Technologies LLC, Midland, MI (US)

(21) Appl. No.: 19/102,054

(22) PCT Filed: Aug. 8, 2023
(86) PCT No.: PCT/US2023/071856

§ 371 Date: Feb. 7, 2025

Related U.S. Application Data
(60) Provisional application No. 63/396,250, filed on Aug. 9, 2022.

(51) Int. Cl. B29C 48/25; B29B 9/06; B29K 23/00

(52) U.S. Cl. CPC B29C 48/254; B29B 9/06; B29K 2023/08

(57) ABSTRACT

Embodiments of an extruder comprise an extruder housing having an internal wall and a single screw coaxially disposed within the extruder housing, the single screw comprising a shank, wherein the shank and/or a region of the internal wall proximate the shank comprises helical channels. The extruder further comprises a feed channel downstream of the shank, and a visco-seal comprising the helical channels and the annular gap between the shank and the internal wall, wherein the annular gap is variable across its length.

### CROSS REFERENCE TO RELATED APPLICATION

This application claims priority to U.S. Provisional Application Ser. No. 63/396,250, filed Aug. 9, 2022, which is hereby incorporated by reference in its entirety.

### TECHNICAL FIELD

The present specification generally relates to single screw extruders used in polymer processing, and relates in particular, to visco-seals used in these single screw extruders.

### BACKGROUND

Visco-seals are placed on the shank of melt-fed, single-screw extruder screws using a helical channel cut into either the screw shank or the extruder wall. These screws are typically used in large-diameter extruders that are used to pelletize resins produced from polymer resin production plants. While most of the polymer resin is delivered to the feed channel of the extruder, a small portion of the resin is transferred into the annular gap created between the shank of the screw and the wall between the start of the feed channel and the drive end of the screw. The helical channels, which pump the resin back into the main flow path of the screw, and the annular gap comprise the visco-seal of the extruder. Without a visco-seal, resin would undesirably flow out of the extruder. The visco-seal is also designed to maintain the resin in the extruder during high-pressure events, i.e., when pressure is 40 psig and greater. In some instances, the feed tank or low pressure separator may also have a rupture disk, which fails and thereby lowers the pressure when subjected to high pressures such as 40 psig and greater.

While conventional visco-seals may be able to maintain polymer resin within the extruder even during high-pressure events, visco-seals often struggle as gas seals. Specifically, the gas seals need to prevent atmospheric oxygen from flowing into the extruder, even if separate environmental seals are included. Atmospheric oxygen may cause oxidative degradation of the resin, leading to crosslinked material and black specks, which may render the resin unusable. Moreover, without effective gas sealing, trace amounts of dissolved ethylene gas may escape out of the extruder through the annular gap.

As a result, there is a need for visco-seals, which can maintain polymer resin within the extruder even during high-pressure events while also acting as a suitable gas seal.

### SUMMARY

Embodiments of the present disclosure meet this need by utilizing a visco-seal having a variable annular gap. Without being limited by theory, the variable annular gap adjusts the seal filled length, which synergistically maintains polymer resin within the extruder while also providing a gas seal for the extruder. In this case, the visco-seal's ability to act as a gas seal may include blocking atmospheric oxygen from entering the extruder, and blocking unreacted ethylene from exiting the extruder.

According to one embodiment, an extruder is provided. The extruder comprises an extruder housing having an internal wall and a single screw coaxially disposed within the extruder housing, the single screw comprising a shank, wherein the shank and/or a region of the internal wall proximate the shank comprises helical channels. The extruder further comprises a feed channel downstream of the shank, and a visco-seal comprising the helical channels and also comprises an annular gap between the shank and the internal wall, wherein the annular gap is variable across its length.

Additional features and advantages will be set forth in the detailed description which follows, and in part will be readily apparent to those skilled in the art from that description or recognized by practicing the embodiments described herein, including the drawings, the detailed description which follows and the claims.

### BRIEF DESCRIPTION OF THE DRAWINGS

FIG. 1 is a schematic view of a single screw extruder having a tapered internal wall according to one or more embodiments of the present disclosure;

FIG. 2 is an enlarged view of the visco-seal of the single screw extruder of FIG. 1 according to one or more embodiments of the present disclosure;

FIG. 3 is a schematic view of a single screw extruder having a tapered screw shank according to one or more embodiments of the present disclosure; and

FIG. 4 is a schematic view of a single screw extruder having a barrel wall with helical flights according to one or more embodiments of the present disclosure.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term interpolymer thus includes copolymers, and polymers prepared from more than two different types of monomers, such as terpolymers.

“Polyethylene” or “ethylene based polymer” shall mean polymers comprising greater than 50% by weight of units, which have been derived from ethylene monomer. This includes polyethylene homopolymers or copolymers (meaning units derived from two or more comonomers). Comonomers may include olefin comonomers as well as polar comonomers. Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

As used herein, “high-pressure polymer resin” are polymers produced at pressures above 14,500 psi (100 MPa) and may include high-pressure copolymers or homopolymers. This may include ethylene homopolymer, such as LDPE, or ethylene copolymer. The term “LDPE” may also be referred to as “high-pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 grams per cubic centimeter (g/cm³) to 0.935 g/cm³.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

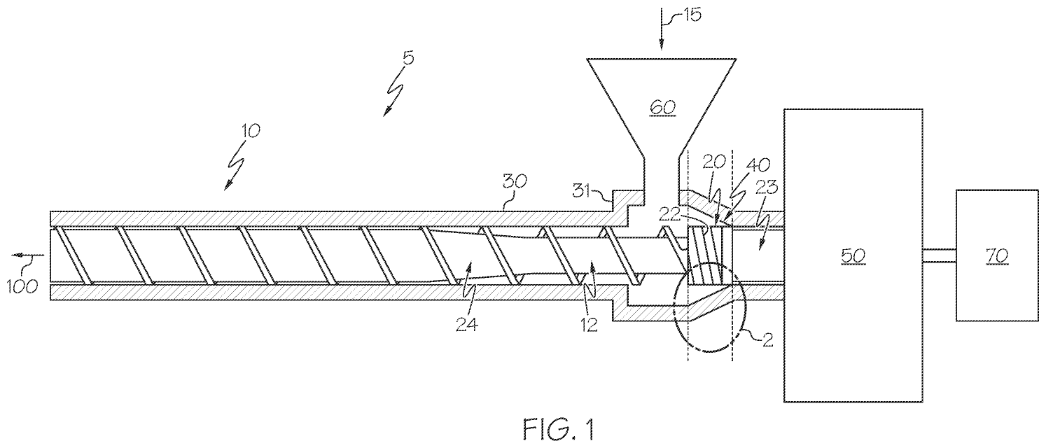

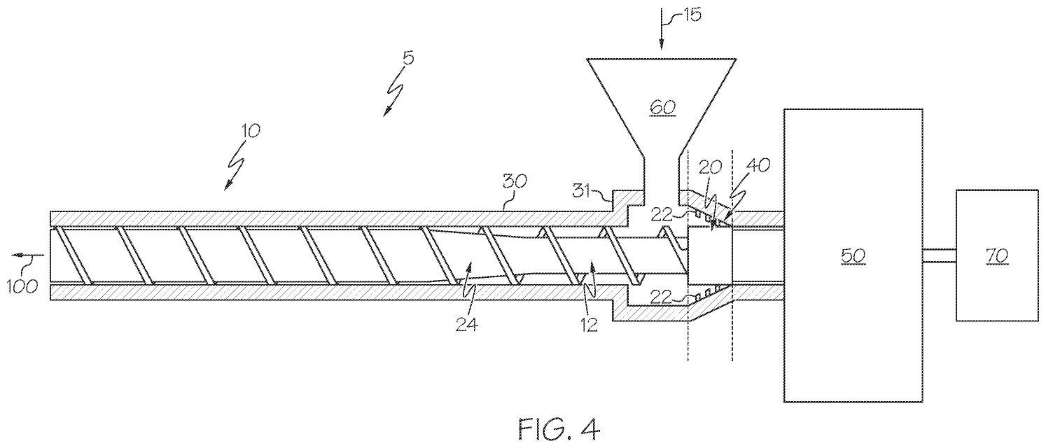

Referring to FIGS. 1, 3, and 4, embodiments of the present disclosure are directed to an extruder 5 comprising an extruder housing 10 having an internal wall 30 as shown. The extruder 5 comprises a single screw 12 coaxially disposed within the extruder housing 10. The single screw 12 comprises a shank 20. As shown in FIGS. 1-3, the shank 20 may comprise helical channels 22. As shown in FIG. 4, a region of the internal wall 30 proximate the shank 20 comprises helical channels 22.

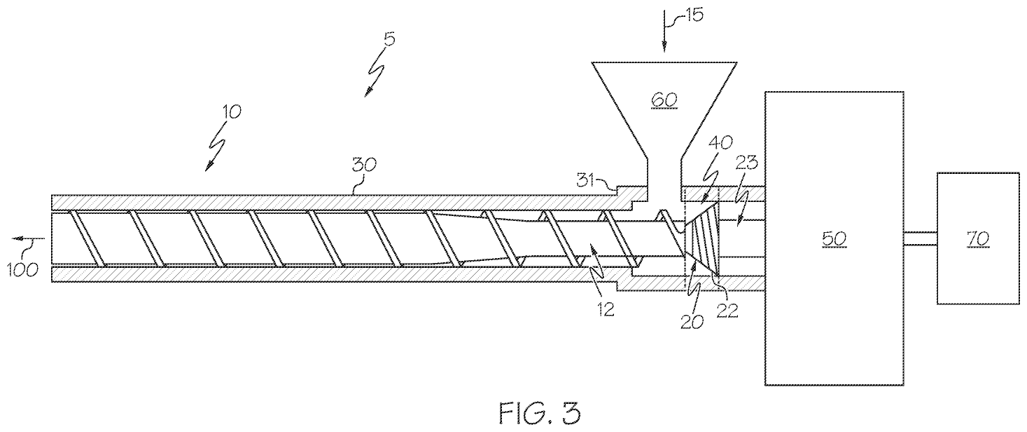

Referring again to FIGS. 1 and 3, the extruder includes a feed channel 24 downstream of the shank 20. Moreover, the extruder 20 comprises a visco-seal, which includes the helical channels 22 and an annular gap 40 between the shank 20 and the internal wall 30. As shown in FIGS. 1-3, the visco-seal encompasses the annular gap 40 and the helical channels 22 of the shank 20.

Referring again to FIGS. 1 and 3, the extruder 5 further comprises a low-pressure separator (LPS) 60 upstream of the feed channel 24. The LPS 60 is used to remove a portion of the unreacted gas (e.g., unreacted ethylene gas) from the molten polymer resin. The LPS 60 operates normally between about 2 to 10 psig, from 4 to 8 psig, at least 5 psig, or 6 psig. The pressure from the LPS 60 forces most of the molten polymer resin into the feed channel 24 of the extruder 5; however, as discussed above, a small portion of the resin may be introduced into the annular gap 40.

Moreover, the extruder 5 may comprise a gearbox 50 coupled to a drive end 23 of the single screw 12. As shown, the shank 20 and annular gap 40 is disposed between the drive end 23 of the single screw 22 and the feed channel 24.

As noted above and shown in FIGS. 1-3, the annular gap 40 is variable across its length. In specific embodiments of the variable length, the annular gap 40 tapers in a direction away from the feed channel 24. In one or more embodiments, the annular gap 40 tapers to at least half of its original maximum thickness, or least one third of its original maximum thickness.

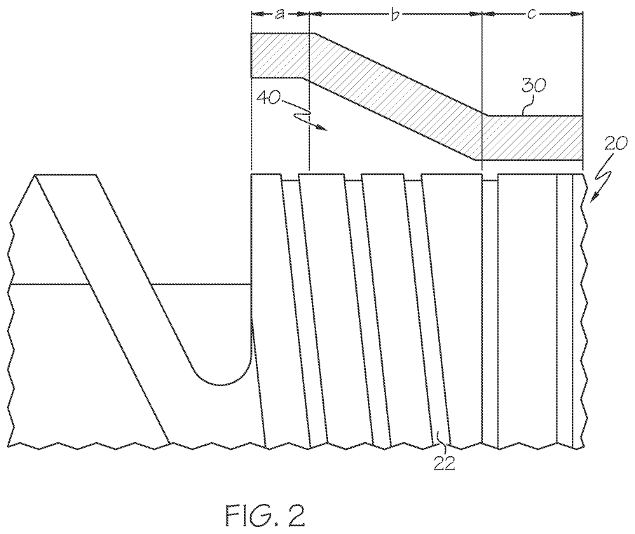

Referring to the embodiment depicted in FIG. 2, the narrow end c of the annular gap (i.e., the end of the taper) may be 0.1 to 1.0%, or 0.3 to 0.4% of the diameter of the screw. For a 12 inch diameter screw, the typical clearance at the narrow end c of the annular gap 40 would be 0.012 to 0.120 inches, 0.036 to 0.048 inches. At the wide gap a located at the start of the visco-seal taper, the clearance may be from 2 to 5 times the clearance at the narrow end. For example, the typical clearance at the wide end a of the annular gap 40 would be 0.3 to 3.0%, or 0.9 to 1.2% of the screw diameter. Without being limited by theory, the narrow end c ensures there is significant pressure to keep pumping the molten resin in the case of a high-pressure event (i.e., a pressure of at least 40 psig), while the wide end a and the transition regime b ensures that the visco-seal has a sufficient seal fill length for gas seal performance.

Referring again to the embodiment of FIGS. 1 and 2, the internal wall 30 comprises a variable diameter in the region (see a, b, c regions) proximate the shank 20 to form the variable annular gap 40. In this case, the internal wall 30 tapers while the shank 20 diameter remains substantially constant to thereby form the variable annular gap 40.

In an alternative embodiment depicted in FIG. 2, the shank 20 may comprise a variable diameter to form the variable annular gap. In this case, the shank 30 tapers while the internal wall 30 diameter remains substantially constant to thereby form the variable annular gap 40.

Without being bound by theory, the ability of the present variable annular gap visco-seal to act as a gas seal may correlate to the seal fill length. In one or more exemplary embodiments, the seal fill length of the polymer resin in the annular gap is from 15 to 45 mm at a pressure of 5 to 6 psig and a diameter of about 18 inches (457.2 mm). In a further embodiment, the seal fill length of the polymer resin may be from 20 to 40 mm at a pressure of 5-6 psig.

Moreover, the ability of the present variable annular gap visco-seal to act as a gas seal may correlate to the seal length defined by the ratio of seal filled length to the diameter of the single screw. In one or more embodiment, the ratio is from 4 to 40%, 4 to 25%, from 5 to 20%, or from 5 to 15%. Without being bound by theory, values below the 4% lower limit will not achieve the desired gas seal performance. As stated above, an acceptable gas seal regulates gas flow between the inside and outside of the extruder such that atmospheric oxygen cannot intrude into the extruder and ethylene gas cannot escape out of the extruder through the shank.

In operation, the extruder 5 may be used for pelletization of polymer resin. As shown in FIGS. 1 and 3, molten polymer resin 15 may be passed from the LPS 60 to the feed channel 24 at a pressure of at least 5 psig. The visco-seal may assist in transporting any molten polymer resin within the variable annular gap 40 back to the feed channel 24. The pelletized polymer is produced and discharge from an outlet 100 of the extruder 5.

### Test Methods

### Density

Samples for density are measured according to ASTM D792, Method B.

### Melt Index (I₂)

Melt index, or I₂, (grams/10 minutes or dg/min) is measured in accordance with ASTM D 1238, Condition 190° C./2.16 kg, Procedure B.

### Seal Length

The helical section of the seal was set between 0.3 and 0.5 diameters in axial length. The grooves had 2 to 4 starts, a lead length of 0.15 to 0.30 diameters, groove depth of 0.005 to 0.008 diameters, and a width of 0.2 to 0.4 diameters. As described further below, calculations were performed on Simcenter STAR-CCM+ software package.

### Examples

Embodiments will be further clarified by the following examples.

The following commercial resins were used in the examples.

AGILITY™ 1000 is a high-pressure LDPE having a density of 0.920 g/cm³ and a melt index (I₂) of 0.15 g/10 min. available from Dow Inc., Midland, MI.

DXM-445 is a high-pressure LDPE having a density of 0.920 g/cm³ and an I₂ of 2 g/10 min. available from Dow Inc., Midland, MI.

DOW™ LDPE132i is a is a high-pressure LDPE having a density of 0.921 g/cm³ and an I₂ of 0.25 g/10 min. available from Dow Inc., Midland, MI.

### Constant Annular Gap Visco-Seal Examples

Several numerical simulations were performed using the Simcenter STAR-CCM+ computational fluid dynamics (CFD) software. One such example was performed for a visco-seal having a constant annular gap of 0.035 inches. This molten seal was only about 2-3 mm in length for an 18-inch (457.2 mm) diameter screw extruder. All three commercial resins were evaluated. A fill length of 2-3 mm is not sufficient to maintain a gas seal. As shown in Table 1, the seal fill lengths for each of the three resins were insufficient to maintain a gas seal. For a high pressure event (40 psig), the fill length ranged from 9.4 to 14.55 mm, lengths that were well within the helical geometry of the seal, and thus capable of maintaining resin in the extruder.

Additional numerical simulations were also performed for a visco-seal with a constant annular gap 0.100 inch. The resin used was DOW™ LDPE132i. In this case, a fill length of 26.8 mm was achieved, thus providing an acceptable gas seal. However, a constant annular gap of 0.100 inch could only withstand a pressure of about 32 psig. Thus, a high-pressure event of 40 psig could cause resin to flow out of the extruder.

### Variable Annular Gap Visco-Seal Examples

As further shown in Table 1, numerical simulations were also performed for a visco-seal with a variable annular gap. At the pocket of the screw, the annular gap was 0.100 inch so that enough molten resin provided an acceptable gas seal. The annular gap then tapered over the next 160.5 mm to a small gap of 0.035 inch, thereby providing acceptable pumping during a high-pressure event. The annular gap was formed by adjusting the diameter of the internal wall as shown in FIGS. 1 and 2.

TABLE 1
Simulation Results - Seal filled length
(mm) as a function of LPS pressure (psi)

| | Constant Annular | | | |
|---|---|---|---|---|
| | Gap (0.035 mm) | | Variable Annular Gap | |
| | Seal | Seal Filled | Seal | Seal Filled |
| LPS | Filled | Length/Screw | Filled | Length/Screw |
| Pressure | Length | Diameter | Length | Diameter |
| (psi) | (mm) | ratio | (mm) | ratio |
| | AGILITY ™ 1000 | | | |
| 5 | 2.03 | 0.4% | 19.1 | 4.2% |
| 10 | 2.92 | 0.6% | 43.2 | 9.5% |
| 20 | 4.42 | 1.0% | 77.19 | 16.9% |
| 30 | 6.59 | 1.4% | 102.47 | 22.4% |
| 40 | 9.4 | 2.1% | 114 | 24.9% |
| | DXM-445 | | | |
| 5 | 2.76 | 0.6% | 41.49 | 9.1% |
| 10 | 4.51 | 1.0% | 60.67 | 13.3% |
| 20 | 7.7 | 1.7% | 107.42 | 23.5% |
| 30 | 10.52 | 2.3% | 142.32 | 31.1% |
| 40 | 14.55 | 3.2% | 156.52 | 34.2% |
| | DOW ™ LDPE132i | | | |
| 5 | 2 | 0.4% | 26.78 | 5.9% |
| 10 | 3.01 | 0.7% | 47.6 | 10.4% |
| 20 | 5.5 | 1.2% | 87.6 | 19.2% |
| 30 | 7.7 | 1.7% | 107.95 | 23.6% |
| 40 | 10.5 | 2.3% | 121.1 | 26.5% |

As shown in the above examples, the constant annular gap (0.035) visco-seal examples exhibit a maximum ratio of 1% for seal filled length/screw diameter at low pressure (5-10 psig). This is an insufficient seal length to achieve suitable gas seal properties. In contrast, the variable annular gap visco-seal examples yielded values greater than 4% for the seal filled length/screw diameter ratio at low pressure (5-10 psig). As a result, the variable annular gap visco-seal is a suitable gas seal.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. An extruder comprising:
an extruder housing having an internal wall;
a single screw coaxially disposed within the extruder housing, the single screw comprising a shank, wherein the shank and/or a region of the internal wall proximate the shank comprises helical channels;
a feed channel downstream of the shank; and
a visco-seal comprising the helical channels and also comprising an annular gap between the shank and the internal wall, wherein the annular gap is variable across its length.

2. The extruder of claim 1, wherein the annular gap tapers away from the feed channel.

3. The extruder of claim 1, wherein the annular gap tapers to at least half of its original maximum thickness, or least one third of its original maximum thickness.

4. The extruder of claim 1, wherein the internal wall comprises a variable diameter in the region proximate the shank to form the variable annular gap.

5. The extruder of claim 1, wherein the shank comprises a variable diameter to form the variable annular gap.

6. The extruder of claim 1, wherein shank comprises helical channels.

7. The extruder of claim 1, wherein the internal wall comprises helical channels.

8. The extruder of claim 1, further comprising a low pressure separator upstream of the feed channel.

9. The extruder of claim 1, further comprising a gearbox coupled to a drive end of the single screw, wherein the shank and annular gap is disposed between the drive end of the single screw and the feed channel.

10. A method of pelletizing polymer resin from the extruder of claim 1, the method comprising:
passing molten polymer resin from to the feed channel at a pressure of at least 5 psig;
utilizing the visco-seal to transport any molten polymer resin within the variable annular gap back to the feed channel; and
producing the pelletized polymer resin at an outlet of the extruder.

11. The method of claim 10, wherein the polymer comprises ethylene homopolymer or ethylene copolymer.

12. The method of claim 10, wherein the visco-seal is defined by a ratio of seal filled length to diameter of the single screw, wherein the ratio is from 4 to 40%, or from 5 to 15%.
